(19) United States
(12) Patent Application Publication
(10) Pub. No.: US 2026/0008255 A1
(43) Pub. Date: Jan. 8, 2026

(54) LAMINATED PANE WITH A PLURALITY OF REFLECTION REGIONS

(71) Applicant: SAINT-GOBAIN GLASS FRANCE, COURBEVOIE (FR)

(72) Inventors: Sebastian ARENDT, HERZOGENRATH (DE); Jan HAGEN, HERZOGENRATH (DE); Yahya MOTEMANI SHARABIANI, HERZOGENRATH (DE); Sebastian JANZYK, HERZOGENRATH (DE); Andreas GOMER, HERZOGENRATH (DE)

(21) Appl. No.: 18/880,487

(22) PCT Filed: Jun. 27, 2023
(86) PCT No.: PCT/EP2023/067370

§ 371 Date: Dec. 31, 2024

(30) Foreign Application Priority Data
Jul. 19, 2022 (EP) 22185693.3

(51) Int. Cl. B32B 17/10

(52) U.S. Cl. CPC B32B 17/10036; B32B 17/1022; B32B 17/10449; B32B 17/10779; B32B 17/10788; B32B 2307/41; B32B 2307/412; B32B 2307/416; B32B 2307/7376; B32B 2311/08; B32B 2605/00

(57) ABSTRACT

A laminated pane for a projection arrangement includes an outer pane, a thermoplastic intermediate layer, and an inner pane, a partially transparent reflection layer, and an opaque reflection layer, wherein the partially transparent reflection layer and the opaque reflection layer are arranged between the outer pane and the inner pane, wherein the opaque reflection layer is arranged outside a look-through region of the laminated pane and the partially transparent reflection layer extends over at least the entire look-through region of the laminated pane, wherein the opaque reflection layer reflects visible light to an extent of at least 30% and the partially transparent reflection layer reflects visible light to an extent of at most 30%.

The invention relates to a laminated pane for a projection arrangement, to a method for the production thereof, to the use thereof, and to a projection arrangement comprising the laminated pane.

Modern automobiles are increasingly equipped with so-called head-up displays (HUDs). With a projector, typically in the region of the dashboard, images are projected onto the look-through region of the windshield, are reflected there, and are perceived by the driver as a virtual image behind the windshield (as seen from the driver's position). Important information can thus be projected into the field of vision of the driver, for example the current travel speed, navigation information or warnings, which the driver can perceive without having to avert their gaze from the road. Head-up displays can thus contribute substantially to increasing traffic safety.

It is also known to equip the windshield with a reflection layer, which, although it allows looking through the windshield, nevertheless reflects the projector radiation to a significant degree. The angle of incidence of the projector radiation on the windshield is typically about 65°, which is close to the Brewster angle for an air-glass transition (56.5° for soda-lime glass). If the projector is operated with s-polarized radiation, the radiation is reflected on the external surfaces of the windshield. In this case, an additional reflection layer can be used to amplify the intensity of the display image. If the projector is operated with p-polarized radiation, this is not substantially reflected on the pane surfaces. In this case, a reflection layer is absolutely necessary to realize the HUD. A coating with at least one metallic layer, in particular silver layer, can be used as a reflection layer, for example. The windshield typically consists of an outer pane and an inner pane which are connected to one another via a thermoplastic intermediate layer. Said coating can be applied, for example, on the surface of the outer pane or of the inner pane facing the intermediate layer or on a PET carrier film which is embedded in the intermediate layer. HUDs with p-polarized radiation with reflection layers are known, for example, from DE102014220189A1, WO2019046157A1 and US2017242247A1. However, purely dielectric reflection films are also known, which are formed from a plurality of individual layers with an alternating high and low refractive index, wherein the reflective effect is generated by optical interference. Such films can also be embedded into the intermediate layer. A laminated pane with such a functional film is known, for example, from WO03099553A1.

Apart from the transparent look-through region, windshields usually have an opaque masking region with an opaque layer, through which it is not possible to look through. The masking region is typically arranged in a peripheral edge region of the windshield and borders the look-through region. The opaque masking region serves primarily to protect the adhesive used for gluing the windshield to the vehicle body against UV radiation. The masking region is typically formed by a black covering print on the surface of the outer pane facing the intermediate layer.

It is possible to generate a virtual image even in the masking region. Thus, the masking region is also irradiated by a projector and the light is reflected there, thereby generating a display for the driver. Thus, for example, information which has been previously displayed in the region of the dashboard, such as the time, travel speed, engine speed, or information of a navigation system, or also the image of a rearward-directed camera, which replaces the conventional exterior mirrors or rearview mirrors, can be displayed directly on the windshield in a practical and aesthetically appealing manner-for example, in the section of the masking region which borders the lower edge of the windshield. A projection arrangement of this type is known, for example, from DE102009020824A1. Homogeneous reflection of light in the masking region presents different requirements on the structure of a laminated pane than those in the case of HUD reflection.

WO2021/213884A1 discloses a projection arrangement comprising at least two reflection regions in a windshield, wherein the type of light reflection in the reflection regions is designed in different ways. WO2022/073894A1 discloses a vehicle pane for a projection arrangement, wherein the reflection layer is arranged in the interior of the vehicle in front of a masking strip.

The object of the present invention is therefore to provide a laminated pane for projection arrangements which can be used as a component both of a conventional HUD projection arrangement and of a projection arrangement with a masking region, wherein homogeneous reflection is achieved for both types of projection arrangements.

The object of the present invention is achieved according to the invention by a laminated pane according to claim 1. Preferred embodiments result from the dependent claims.

The invention relates to a laminated pane for a projection arrangement, comprising an outer pane, a thermoplastic intermediate layer, an inner pane, a partially transparent reflection layer and an opaque reflection layer. The thermoplastic intermediate layer is arranged between the outer pane and the inner pane. The partially transparent reflection layer and the opaque reflection layer are arranged between the outer pane and the inner pane. The opaque reflection layer is arranged outside a look-through region of the laminated pane. The partially transparent reflection layer extends over at least the entire look-through region of the laminated pane.

The look-through region of the laminated pane means the region of the laminated pane that is intended to be looked through. The look-through region is thus free of opaque layers and is at least partially transparent with a light transmittance of at least 50%, preferably at least 70%. If the laminated pane is, for example, a windshield, the look-through region is thus the region through which a viewer can look onto the road.

The opaque reflection layer reflects visible light to an extent of at least 30% and the partially transparent reflection layer reflects visible light to an extent of at most 30%. In the sense of the invention, “reflected” means that the opaque or partially transparent reflection layer reflects visible light impinging on it. In the sense of the invention, the reflection in a specific percentage range means an average reflectance at a defined angle of incidence of 65°. The opaque reflection layer is in particular provided to reflect an image projected onto the reflection layer by a projector.

The opaque and the partially transparent reflection layer are suitably designed to reflect visible light in a wavelength range of 380 nm to 780 nm. The opaque and the partially transparent reflection layer preferably reflect p-polarized and s-polarized light in equal proportions, but they can also reflect p-polarized light and s-polarized light to different degrees. The opaque reflection layer and the partially transparent reflection layer preferably have a high and uniform reflectance (via various irradiation angles) with respect to p-polarized and/or s-polarized radiation so that color-neutral image presentation of strong intensity is ensured. In the reflection of p-polarized light, fewer ghost images occur and an improved visual quality of the reflected light (for example, virtual image) is thus achieved. By admixing s-polarized light, the reflectance can be increased.

The laminated pane can be part of a projection arrangement, wherein the partially transparent reflection layer can be irradiated with a projector and the opaque reflection layer can be irradiated with a further projector. In this case, the projector and the further projector preferably project a virtual image onto the respective reflection layer. As a result of the different reflection properties, a homogeneous image can be achieved both in the look-through region on the partially transparent reflection layer and outside the look-through region on the opaque reflection layer. This is a great advantage of the invention. The projector is an HUD projector, whereas the further projector can be an HUD projector, but it can also be less energy-intensive than customary HUD projectors since, due to the opacity of the opaque reflection layer, the virtual image is easily perceptible even with lower light intensities of the projector.

The outer pane has an outer surface which faces away from the thermoplastic intermediate layer and is also simultaneously the outer surface of the laminated pane. The outer pane also has an interior surface facing the thermoplastic intermediate layer. The interior surface of the inner pane is at the same time the inner surface of the laminated pane. The inner pane additionally has an outer surface facing the thermoplastic intermediate layer. The laminated pane is provided for separating an external environment from an interior, preferably a vehicle interior. The outer surface of the outer pane is provided here to face the external environment and the interior surface of the inner pane is provided to face the interior.

The laminated pane has a peripheral edge, which particularly preferably comprises an upper edge and a lower edge and also two side edges extending therebetween with a left and a right side edge. The top edge refers to the edge which is intended to point upwards in the installed position. The bottom edge refers to the edge which is intended to point downwards in the installed position. The top edge is often also referred to as the roof edge and the bottom edge as the engine edge. The laminated pane can have any suitable geometric shape and/or curvature. The specifications “left” and “right” relate to the specification of sides or directions for a viewer looking at the installed laminated pane according to the invention from an interior.

In a particularly preferred embodiment of the invention, the opaque reflection layer is arranged in front of a masking layer in a view through the laminated pane. The opaque reflection layer is thus arranged in front of an opaque masking layer in a view through the laminated pane in the direction from the inner pane to the outer pane. Conversely, in a view through the laminated pane in the direction from the outer pane to the inner pane, the masking layer covers the entire opaque reflection layer. The masking layer can thus be arranged to be congruent with the opaque reflection layer or can completely cover the opaque reflection layer and additionally extend beyond the surface of the laminated pane. A view in the direction from the inner pane to the outer pane or from the outer pane to the inner pane means a viewing direction arranged perpendicularly to the main surface of the laminated pane. In the sense of the invention, the “complete coverage of an element A by an element B” means that the orthonormal projection of element A to the plane of element B is arranged completely within element B.

The masking layer may be an opaque enamel or may be an opaque thermoplastic film. The masking layer may also be a thermoplastic film that is opaque in regions, and can thus be a component of the thermoplastic intermediate layer. The masking layer is, in particular, a dark, preferably black, enamel, which is applied to the outer pane. The masking layer is preferably applied to the interior surface of the outer pane. The masking layer is preferably a peripheral (frame-like) layer which extends along the peripheral edge of the laminated pane and can be widened in the region of the opaque reflection layer. The masking layer serves primarily as UV protection for the assembly adhesive of the laminated pane (for example for gluing into a vehicle). The masking layer preferably has a transmittance (according to ISO 9050:2003) for visible light of less than 15%, preferably less than 10%, particularly preferably less than 1%. The masking layer can also be designed to be semi-transparent at least in portions, for example as a dot pattern, striped pattern or checkered pattern. Alternatively, the masking layer may also have a gradient, for example from an opaque covering to a semi-transparent covering.

The laminated pane can also have several, preferably two, masking layers, wherein, preferably, a first masking layer is applied to the interior surface of the outer pane and a second masking layer is applied to the interior surface of the inner pane.

In a particularly preferred embodiment of the invention, the masking layer is arranged in a frame-like manner in the peripheral edge region of the laminated pane and widens in a portion of the peripheral edge region adjacent to the lower edge of the laminated pane. The masking layer preferably has, in the widened region, a width of 10 cm or more, particularly preferably 20 cm or more, in particular 30 cm or more. This embodiment is especially suitable for use in vehicles in which the projection arrangement can be used as an alternative to displays installed in the dashboard.

The partially transparent reflection layer has a light transmittance (according to ISO 9050:2003) for light in the visible spectral range of at least 50%, preferably at least 60%, and particularly preferably at least 70%. Furthermore, the partially transparent reflection layer has a light transmittance (according to ISO 9050:2003) for light in the visible spectral range of 90% or less, preferably 80% or less, particularly preferably exactly 70%. In the sense of the invention, “opaque” means a light transmission, i.e., light transmittance (according to ISO 9050:2003), of less than 30%, preferably less than 20%, particularly preferably less than 5%, and in particular less than 0.1%. In the sense of the invention, “partially transparent” means a light transmission of at least 50%, preferably at least 60%, and particularly preferably at least 70%.

The partially transparent reflection layer preferably extends over more than 50%, preferably more than 70%, particularly preferably more than 90%, of the surface of the laminated pane. According to the invention, the partially transparent reflection layer extends at least over the entire region which is provided for looking through the laminated pane. This means the region through which it is possible to look in the finished laminated pane and optionally in the installed state (for example, installation of the laminated pane in a vehicle) and which is at least partially transparent. In particular, the partially transparent reflection layer extends over the entire surface of the laminated pane minus a peripheral frame-like edge region (adjacent to the peripheral edge of the laminated pane). The uncoated peripheral frame-like edge region serves for the better separation of the partially transparent reflection layer from the external environment. The partially transparent reflection layer is thereby better protected against corrosion or mechanical damage. The coating-free edge region preferably has a width of less than 20 cm, particularly preferably less than 10 cm, in particular less than 1 cm. The term “width” in the sense of the invention means the extent perpendicular to the direction of extension.

The opaque reflection layer preferably extends at most over 50%, preferably at most over 40%, particularly preferably at most over 20%, of the surface of the laminated pane. The opaque reflection layer is particularly preferably arranged adjacently to the upper edge, left side edge, right side edge and/or the lower edge of the laminated pane, wherein a coating-free edge region preferably extends between the opaque reflection layer and the upper edge, side edge and/or lower edge. The coating-free edge region preferably has a width of less than 20 cm, particularly preferably less than 10 cm, in particular less than 1 cm. The opaque reflection layer preferably extends in the form of a strip from the one (left) side edge to the other (right) side edge. The opaque reflection layer preferably has a width of at least 10 cm, particularly preferably at least 20 cm, in particular at least 30 cm. The arrangement of the opaque reflection layer in an edge region adjacent to the lower edge, left side edge, right side edge and/or upper edge is expedient in particular if the laminated pane is designed in the form of a vehicle pane, in particular a windshield.

The partially transparent reflection layer typically contains one or more, for example two, three, or four, functional layers. The functional layers preferably contain at least one metal-for example, silver, gold, copper, nickel, and/or chromium, or a metal alloy. The functional layers particularly preferably contain at least 90 wt % of the metal, in particular at least 99.9 wt % of the metal. The functional layers can consist of the metal or the metal alloy. The functional layers particularly preferably contain silver or a silver-containing alloy. The partially transparent reflection layer very particularly preferably contains at most 2 silver layers, in particular at most one silver layer, or consists at most of 2 silver layers, in particular at most of one silver layer. Such functional layers have particularly advantageous electrical conductivity and, at the same time, high transmission in the visible spectral range. The thickness of a functional layer is preferably from 5 nm to 50 nm, and particularly preferably from 8 nm to 25 nm. In this thickness region of the functional layer, an advantageously high transmission in the visible spectral range and a particularly advantageous electrical conductivity are achieved. The partially transparent reflection layer preferably extends in each case over a region of 10 cm² to 1000 cm², particularly preferably of 20 cm² to 100 cm².

Typically, at least one dielectric layer is arranged in each case between two adjacent functional layers of the partially transparent reflection layer. Preferably, a further dielectric layer is arranged below the first and/or above the last functional layer. A dielectric layer contains at least one individual layer made of a dielectric material-for example, containing a nitride such as silicon nitride or an oxide such as aluminum oxide. Dielectric layers can, however, also comprise multiple individual layers, e.g., individual layers of a dielectric material, smoothing layers, matching layers, blocker layers, and/or anti-reflective layers. The thickness of a dielectric layer is, for example, from 10 nm to 200 nm.

The partially transparent reflection layer particularly preferably contains indium tin oxide (ITO), fluorine-doped tin oxide (SnO₂:F) or aluminum-doped zinc oxide (ZnO:Al) or consists thereof.

Alternatively, the partially transparent reflection layer can also contain or consist of carbon nanobud (CNB). CNB are a modification of carbon. The carbon atoms are covalently bonded and form fullerenes which are arranged as tubes in the nanometer range. They combine properties of fullerenes with those of nanotubes, thereby providing high mechanical stability with good electrical properties at the same time.

The geometric layer thickness of the partially transparent reflection layer is preferably at most 1000 nm, particularly preferably at most 100 nm, very particularly preferably at most 15 nm. In particular, the partially transparent reflection layer preferably has a layer thickness of 1 nm to 100 nm, particularly preferably of 10 nm to 50 nm. As a result, an advantageous reflectivity in the IR range can be achieved without reducing the transmission too much. The geometric layer thickness of the partially transparent reflection layer is preferably at least 6 nm, particularly preferably at least 8 nm; in particular, the partially transparent reflection layer has the stated layer thicknesses when it consists of a silver layer. Thinner layer thicknesses can lead to a de-wetting of the layer structure. Particularly preferably, the geometric layer thickness of the partially transparent reflection layer is from 10 nm to 14 nm, in particular from 11 nm to 13 nm.

Where reference is made to thin layers, i.e., layers with a thickness of below 1000 nm, the following applies: If something is formed “on the basis of” a material, it predominantly consists of this material, in particular substantially of this material, besides any impurities or doping. Unless otherwise indicated, the specification of layer thicknesses or thicknesses relates to the geometric thickness of a layer.

The laminated pane according to the invention has, in the region provided with the partially transparent reflection layer, preferably in the spectral range of 380 nm to 780 nm, particularly preferably of 380 nm to 680 nm, an average reflectance with respect to p-polarized radiation of preferably at least 10%, particularly preferably of at least 12%, in particular at least 15%. This generates a projection image of sufficiently strong intensity. Independently thereof, the laminated pane has, in the region provided with the opaque reflection layer, preferably in the spectral range of 380 nm to 780 nm, particularly preferably of 380 nm to 680 nm, an average reflectance with respect to p-polarized radiation of preferably at least 30%, particularly preferably of at least 40%, in particular of at least 70%. The opaque reflection layer and the partially transparent reflection layer can overlap with one another outside the look-through region. In the overlapped region, the percentage proportion of the reflected light is substantially defined by the opaque reflection layer.

The reflectance is measured with an angle of incidence of 65° to the interior surface normal (interior surface of the inner pane), which corresponds, for example, to the irradiation by customary HUD projectors. The spectral range of 380 nm to 680 nm was used to characterize the reflection properties because the visual impression of a viewer is primarily shaped by this spectral range. In addition, it covers the wavelengths relevant to the HUD representation (RGB: 473 nm, 550 nm, 630 nm). The angle of incidence of the projector radiation is the angle between the incident vector of the projector radiation and the interior surface normal (i.e., the surface normal to the interior external surface of the laminated pane, which here at the same time is the interior surface of the inner pane).

The reflectance describes the proportion of the total irradiated radiation that is reflected. It is indicated in % (based upon 100%-emitted radiation) or as a unitless number from 0 to 1 (normalized to the emitted radiation). It forms the reflection spectrum when plotted as a function of the wavelength. Within the scope of the present invention, the statements regarding reflectance (or percentage specifications regarding reflection) with respect to p-polarized, unpolarized or s-polarized radiation relate to the reflectance measured with an angle of incidence of 65° to the interior surface normal. The information on the reflectance or the reflection spectrum relates to a reflection measurement with a light source which radiates uniformly in the observed spectral range with a standardized radiation intensity of 100%.

The above-mentioned desired reflection characteristics of the partially transparent reflection layer or of the opaque reflection layer are achieved in particular by the selection of materials and thicknesses and the structure of the individual layers or layer sequences. The partially transparent and opaque reflection layer can thus be suitably adjusted.

The opaque reflection layer preferably comprises at least one metal selected from a group consisting of aluminum, magnesium, tin, indium, titanium, tantalum, niobium, nickel, copper, chromium, cobalt, iron, manganese, zirconium, cerium, scandium, yttrium, silver, gold, platinum, and palladium, ruthenium, or mixtures thereof. Alternatively or additionally, the reflection layer comprises oxides, carbides, silicon, silicon compounds and/or nitrides selected from a group consisting of boron-doped silicon, silicon-zirconium mixed nitride, silicon nitride, titanium oxide, silicon oxide, titanium carbide, zirconium carbide, silicon-zirconium-aluminum or mixtures thereof. Aluminum, titanium, nickel-chromium and/or nickel are preferably applied to the inner pane or the outer pane since they can have a high reflection for p-polarized or s-polarized light. They are thus particularly suitable as a component of a projection arrangement. The opaque reflection layer preferably has a thickness of 10 nm (nanometers) to 100 μm (micrometers), particularly preferably of 50 nm to 50 μm, in particular of 100 nm to 5 μm.

In a preferred embodiment of the invention, the opaque reflection layer is a coating containing a thin-film stack, i.e., a layer sequence of thin individual layers. This thin-film stack contains one or more electrically conductive layers on the basis of nickel, nickel-chromium, titanium and/or aluminum. The electrically conductive layer on the basis of nickel, nickel-chromium, titanium and/or aluminum provides the opaque reflection coating with basic reflective properties and also with an IR-reflecting effect and electrical conductivity. The electrically conductive layer is formed on the basis of nickel, nickel-chromium, titanium and/or aluminum. The conductive layer preferably contains at least 90 wt % nickel, titanium and/or aluminum, particularly preferably at least 99 wt % aluminum, very particularly preferably at least 99.9 wt % nickel, titanium and/or aluminum. The layer on the basis of aluminum, nickel-chromium, nickel and/or titanium may have dopings, for example palladium, gold, copper or silver. Materials on the basis of aluminum, nickel, nickel-chromium and/or titanium are particularly suitable for reflecting light, particularly preferably p-polarized light. The use of nickel, nickel-chromium, titanium and/or aluminum in reflection layers has proven to be particularly advantageous in the reflection of light. Aluminum, nickel, nickel-chromium and/or titanium are significantly more cost-effective compared to many other metals, such as gold or silver. In addition, these metals have a high chemical and thermomechanical resistance. The individual layers of the thin-film stack preferably have a thickness of 10 nm to 1 μm. The thin-film stack preferably has 2 to 20 individual layers and in particular 5 to 10 individual layers.

In a particularly preferred embodiment of the invention, the opaque reflection layer is a reflective film which is metal-free and reflects visible light beams with a p-polarization. The opaque reflection layer is then preferably a film which functions on the basis of synergistically interacting prisms and reflective polarizers. Such films for the use of reflective layers are commercially available-for example, from the 3M company. In this way, complex metal deposition can be avoided. The opaque reflection layer is preferably arranged as a reflective film within the thermoplastic intermediate layer.

In a further particularly preferred embodiment of the invention, the opaque reflection layer contains
a dielectric layer stack containing TiO₂ layers and SiO₂ layers,
a dielectric layer stack containing SiZrN layers and SiO₂ layers,
a layer stack containing Si:B layers or SiZrAl layers,
a layer stack containing Si layers and SiO₂ layers,
a layer stack containing Si layers and SisN4 layers, or
a carbide layer stack containing TiC layers and/or ZrC layers,
   or consists of one or more of these layer stacks. The described layer stacks have suitable reflection properties in order to achieve a homogeneous image as part of a projection arrangement.

In principle, the partially transparent reflection layer and/or the opaque reflection layer can be applied by physical or chemical vapor deposition, i.e., be a PVD or CVD coating (PVD: physical vapor deposition, CVD: chemical vapor deposition), or by means of the sol-gel process, for example. Such coatings can be produced with particularly high optical quality and with particularly low thickness. If the partially transparent reflection layer and/or the opaque reflection layer are a layer stack, the individual layers of the layer stack are applied consecutively, i.e., in succession. The application of layers by means of the sol-gel process is known to a person skilled in the art and can be taken, for example, from WO2021209201A1.

A PVD coating can be a coating applied by cathode sputtering, in particular a coating applied by magnetic-field-assisted cathode sputtering (magnetron sputtering). Preferably, the opaque reflection layer and the partially transparent reflection layer are applied by magnetron sputtering. By means of magnetron sputtering, a homogeneous layer of a thickness of a few nanometers can be efficiently created.

If the opaque reflection layer and/or the partially transparent reflection layer is applied by means of chemical vapor deposition, this is preferably done by means of plasma-enhanced chemical vapor deposition (PECVD); in particular, this production takes place at atmospheric pressure (APCVD). The advantage of plasma-enhanced chemical vapor deposition is the speed of application with, at the same time, high homogeneity of the layers compared to many other methods. In particular silicon oxide can be applied homogeneously and efficiently on a substrate by means of this production.

The opaque reflection layer is preferably applied to the outer surface of the inner pane by physical vapor deposition (PVD), particularly preferably by cathode sputtering, very particularly preferably by magnetic-field-assisted cathode sputtering (magnetron sputtering). The opaque reflection layer is preferably applied before the lamination. Instead of applying the opaque reflection layer to a pane surface, it can in principle also be applied to a carrier film which is arranged in the intermediate layer.

Preferably, the partially transparent reflection layer and/or the opaque reflection layer are applied to the interior surface of the outer pane or to the outer surface of the inner pane. The partially transparent reflection layer and/or the opaque reflection layer can also be applied to the masking layer and/or the outer surface of the inner pane and/or the interior surface of the outer pane. Alternatively, the partially transparent reflection layer and/or the opaque reflection layer can also be applied to a film, preferably formed from an organic polymer, and the film provided with the partially transparent reflection layer and/or the opaque reflection layer can be arranged within the thermoplastic intermediate layer.

In a particularly preferred embodiment, the opaque reflection layer is applied to the outer surface of the inner pane. Preferably, the partially transparent reflection layer is likewise applied to the outer surface of the inner pane. If the partially transparent reflection layer already overlaps in regions with the opaque reflection layer, the opaque reflection layer is preferably applied to the outer surface in this region and the partially transparent reflection layer is applied to the opaque reflection layer in this region. The application of the opaque reflection layer and the partially transparent reflection layer to the outer surface of the inner pane improves the reflection properties of the layers with respect to double images through the surfaces of the inner pane. In that the opaque reflection layer is applied directly to the outer surface of the inner pane and not completely or only in regions to the partially transparent reflection layer, improved color homogeneity is achieved.

Alternatively, the partially transparent reflection layer is applied on the outer surface of the inner pane and the opaque reflection layer is applied in regions or completely to the partially transparent reflection layer. The proportion of the opaque reflection layer that is optionally not applied to the partially transparent reflection layer is applied to the outer surface of the inner pane. This arrangement enables a simplified production method of the laminated pane according to the invention; since the partially transparent reflection layer is preferably applied over a majority of the surface of the laminated pane, its application is preferably carried out before the application of the opaque reflection layer.

In a very particularly preferred embodiment, the opaque reflection layer is applied to a region of the partially transparent reflection layer. According to the invention, the region of the partially transparent reflection layer is located outside the look-through region of the laminated pane. Preferably, the partially transparent reflection layer extends over at least 50%, particularly preferably at least 70%, in particular at least 90% of the surface of the laminated pane.

In a preferred embodiment, the opaque reflection layer is applied to the interior surface of the outer pane. Alternatively, the opaque reflection layer is a reflective film and is arranged within the thermoplastic intermediate layer. As a result of this arrangement, the opaque reflection layer can also be inserted after the coating of the panes, which optimizes production processes.

In a further preferred embodiment, the masking layer is arranged between the outer pane and the inner pane. The masking layer is thus better protected from external influences. The partially transparent reflection layer is preferably arranged between the masking layer and the opaque reflection layer in the view through the laminated pane. As a result, the reflection properties of the opaque reflection layer are not reduced.

The individual layers of the laminated pane are preferably arranged in one of the following sequences:
outer pane—thermoplastic intermediate layer—partially transparent reflection layer—opaque reflection layer—inner pane,
outer pane—thermoplastic intermediate layer—opaque reflection layer—partially transparent reflection layer—inner pane,
outer pane—partially transparent reflection layer—opaque reflection layer—thermoplastic intermediate layer—inner pane,
outer pane—opaque reflection layer—partially transparent reflection layer—thermoplastic intermediate layer—inner pane,
outer pane—masking layer—thermoplastic intermediate layer—partially transparent reflection layer—opaque reflection layer—inner pane,
outer pane—masking layer—thermoplastic intermediate layer—opaque reflection layer—partially transparent reflection layer—inner pane,
outer pane—thermoplastic intermediate layer—masking layer—partially transparent reflection layer—opaque reflection layer—inner pane,
outer pane—thermoplastic intermediate layer—masking layer—opaque reflection layer—partially transparent reflection layer—inner pane,
outer pane—thermoplastic intermediate layer—partially transparent reflection layer—masking layer—opaque reflection layer—inner pane,
outer pane—masking layer—partially transparent reflection layer—opaque reflection layer—thermoplastic intermediate layer—inner pane, and
outer pane—masking layer—opaque reflection layer—partially transparent reflection layer—thermoplastic intermediate layer—inner pane.

The opaque reflection layer and the partially transparent reflection layer cannot be applied congruently since the partially transparent reflection layer extends at least over the look-through region of the laminated pane and the opaque reflection layer does not extend over the look-through region of the laminated pane. In the preferred layer sequence shown, the opaque reflection layer and the partially transparent reflection layer are therefore stacked in the sequence shown only in an optionally present region in which they overlap with one another. In all other regions, either the opaque reflection layer or the partially transparent reflection layer is present (or none of the two layers). By way of example, this is shown for the following layer sequence:
outer pane—thermoplastic intermediate layer—partially transparent reflection layer—opaque reflection layer-inner pane.

In a region in which the partially transparent reflection layer and the opaque reflection layer overlap, the partially transparent reflection layer is thus arranged on the opaque reflection layer. In the look-through region, no opaque reflection layer is present according to the invention so that the partially transparent reflection layer is arranged on the outer surface of the inner pane.

The outer pane and the inner pane are preferably made of transparent or partially transparent glass, in particular of soda-lime glass, which is customary for window panes. In principle, however, the panes can also be produced from other types of glass (for example borosilicate glass, quartz glass, aluminosilicate glass) or transparent plastics (for example polymethyl methacrylate or polycarbonate). The thickness of the outer pane and the inner pane can vary widely. Preferably, panes having a thickness in the range of 0.8 mm to 5 mm, preferably of 1.4 mm to 2.5 mm, are used, for example those with the standard thicknesses of 1.6 mm or 2.1 mm. Independently of each other the outer pane and the inner panes can be not prestressed, partially prestressed or prestressed. If at least one of the panes should be prestressed, this can be thermal or chemical prestressing.

The thermoplastic intermediate layer is preferably formed as at least one thermoplastic composite film and is formed on the basis of ethylene vinyl acetate (EVA), polyvinyl butyral (PVB) or polyurethane (PU), or mixtures or copolymers or derivatives thereof, particularly preferably on the basis of polyvinyl butyral (PVB) and additionally additives, such as plasticizers, known to the person skilled in the art. The thermoplastic film preferably contains at least one plasticizer.

The thermoplastic intermediate layer can be formed by a single film or also by more than one film. The thermoplastic intermediate layer can be formed by one or more thermoplastic films arranged one above the other, wherein the thickness of the thermoplastic intermediate layer after lamination of the layer stack is preferably from 0.25 mm to 1 mm, typically 0.38 mm or 0.76 mm. The thermoplastic intermediate layer can also be formed from a film which is colored and thus opaque in regions. The masking layer can also be a component of the thermoplastic intermediate layer. The intermediate layer can also be formed from more than one film and the at least two films extend over different regions of the surface of the laminated pane.

The thermoplastic intermediate layer can also be a functional thermoplastic film, in particular a film with acoustically damping properties, a film reflecting infrared radiation, a film absorbing infrared radiation and/or a film absorbing UV radiation. For example, the thermoplastic intermediate layer can thus also be a band filter film.

The outer pane, the inner pane and the laminated pane can have any three-dimensional shape. Preferably, the inner pane and the outer pane do not have any shadow zones so that they can be coated efficiently by cathode sputtering. The inner pane and outer pane and thus also the laminated pane are preferably flat or slightly or strongly curved in one direction or in several directions of space.

If something is formed “on the basis of” a polymeric material, it predominantly consists of this material, i.e., at least to an extent of 50%, preferably at least to an extent of 60%, and in particular at least to an extent of 70%. It may thus also contain further materials, such as stabilizers or plasticizers.

A further aspect of the invention relates to a projection arrangement comprising a laminated pane according to the invention, a projector, which projects an image, preferably via the inner pane, onto the partially transparent reflection layer, and a further projector which projects an image, preferably via the inner pane, onto the opaque reflection layer. In other words: the respective projector irradiates the opaque or partially transparent reflection layer with visible light, wherein the respective reflection layer at least partially reflects the visible light. The projector and the further projector preferably face the interior surface of the inner pane. If the laminated pane is irradiated in an installed state (for example, as a windshield in a vehicle), the projector and the further projector irradiate the reflection layer or the HUD region from an interior (vehicle interior).

The radiation of the projector and/or of the further projector is preferably predominantly p-polarized, thus has a p-polarized radiation proportion of greater than 50%. The higher the proportion of the p-polarized radiation in the total radiation of the projector, the stronger the intensity of the desired projection image and the weaker the intensity of undesired reflections at the surfaces of the windshield. The p-polarized radiation proportion of the projector is preferably at least 70%, particularly preferably at least 80%, and in particular at least 90%. In a particularly advantageous embodiment, the radiation of the projector is substantially purely p-polarized; the p-polarized radiation component is thus 100% or deviates only insignificantly therefrom.

The indication of the polarization direction refers to the plane of incidence of the radiation on the laminated pane. P-polarized radiation refers to a radiation the electric field of which oscillates in the plane of incidence. P-polarized radiation refers to a radiation the electric field of which oscillates perpendicular to the plane of incidence. The plane of incidence is spanned by the incident vector and the surface normal of the laminated pane in the geometric center of the irradiated region.

If the projection arrangement is a component of a vehicle, the projector and the further projector are preferably arranged in the dashboard of the vehicle. The image projected onto the reflection layer by the projector is reflected into the vehicle interior, for example into the field of vision of an occupant. Due to the opaque reflection layer, which is optionally additionally arranged in front of the masking layer, the image projected onto the opaque reflection layer can be perceived visually at high contrast. As a result, projectors with a lower energy requirement can be used. In comparison to projectors for conventional head-up displays, the energy requirement of the projector can be reduced by up to 20%.

The projector and/or the further projector are preferably a liquid crystal (LCD) display, thin-film transistor (TFT) display, light-emitting diode (LED) display, organic light-emitting diode (OLED) display, electroluminescent (EL) display or microLED display.

As is usual in the case of HUDs and projection arrangements based on a similar technology, the projector and the further projector irradiate the respective reflection layer, i.e., a projection surface of the reflection layer, in particular with a p-polarized radiation in the wavelength range of 380 nm to 780 nm. The p-polarized radiation is reflected in the region of the projection surface in the direction of a viewer, as a result of which a virtual image is generated which the viewer perceives behind the laminated pane as seen from the viewer (in the case of an HUD). The beam direction of the projector and/or of the further projector can typically be varied by mirrors, in particular vertically, in order to adapt the projection to the body size of the viewer. The region in which the viewer's eyes must be located at a given mirror position is referred to as the eyebox window. This eyebox window can be displaced vertically by adjusting the mirrors, wherein the entire region accessible as a result (i.e., the superimposition of all possible eyebox windows) is referred to as an eyebox. A viewer located within the eyebox can perceive the virtual image. This means, of course, that the viewer's eyes must be located within the eyebox and not the entire body, for example.

The technical terms used here from the field of HUDs are generally known to the person skilled in the art. For a detailed presentation, reference can be made to the dissertation entitled “Simulation-based measurement technology for testing head-up displays” by Alexander Neumann at the Institute for Informatics of the Technical University of Munich (Munich: University library of TU Munich, 2012), in particular to Chapter 2 “The head-up display.”

The above statements and preferred embodiments in connection with the laminated pane or the projection arrangement apply equally to the method. The following statements and preferred embodiments in connection with the method according to the invention apply equally to the laminated pane and projection arrangement.

A further aspect of the invention relates to a method for producing the laminated pane according to the invention. The method steps comprise, preferably in the stated sequence, the following method steps:

(A) a layer stack formed of the outer pane, the thermoplastic intermediate layer (4) and the inner pane is provided,
(B) the partially transparent reflection layer and the opaque reflection layer are arranged between the outer pane and the inner pane, and
(C) the layer stack is laminated to form the laminated pane.

In a preferred embodiment, the second method step (B) is divided into three individual steps:

(B.1) The partially transparent reflection coating is applied to the outer pane or the inner pane, preferably to the interior surface of the inner pane.
(B.2) The inner pane and the outer pane are bent in a bending method so that they preferably meet the requirements of a windshield for a vehicle.
(B.3) The opaque reflection layer is applied to the curved outer pane and optionally the partially transparent reflection layer, or the opaque reflection layer is applied to the curved inner pane and optionally the partially transparent reflection layer.

Lamination of the layer stack takes place under the action of heat, vacuum, and/or pressure, wherein the individual layers are bonded (laminated) by at least one thermoplastic film. Methods known per se may be used to manufacture a composite pane. For example, so-called autoclave processes can be carried out at an elevated pressure of about 10 bar to 15 bar and temperatures of 130° C. to 145° C. over about 2 hours. Vacuum-bag or vacuum-ring methods known per se operate, for example, at approximately 200 mbar and 130°° C. to 145° C. The layer stack may also be pressed in a calender between at least one pair of rollers to form a laminated pane. Installations of this type for the manufacture of composite panes are known and usually have at least one heating tunnel upstream of a pressing unit. The temperature during the pressing process, for example, ranges from 40° C. to 150° C. In practice, combinations of calendering and autoclaving methods have proved particularly successful. Alternatively, vacuum laminators may be used. They consist of one or more heatable and evacuable chambers, in which the outer pane and the inner pane can be laminated within, for example, approximately 60 minutes at reduced pressures of 0.01 mbar to 800 mbar and temperatures of 80° C. to 170° C.

The laminated pane according to the invention can, for example, be the roof pane, windshield, side pane, or rear pane of a vehicle, or another vehicle glazing, for example a separating pane in a vehicle, preferably in a rail vehicle, a car or bus. Alternatively, the laminated pane can be an architectural glazing, for example in an outer facade of a building or a separating pane inside a building, or a component in furniture or devices.

The invention is explained in more detail with reference to drawings and embodiments. The drawings are schematic representations and not to scale. The drawings do not limit the invention in any way. In the drawings:

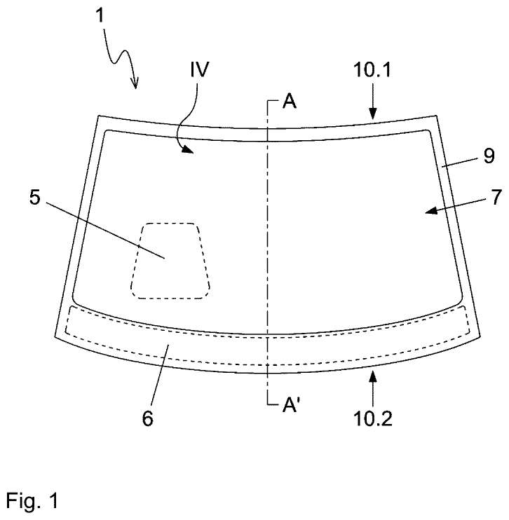

FIG. 1 shows an embodiment of the laminated pane according to the invention in a plan view,

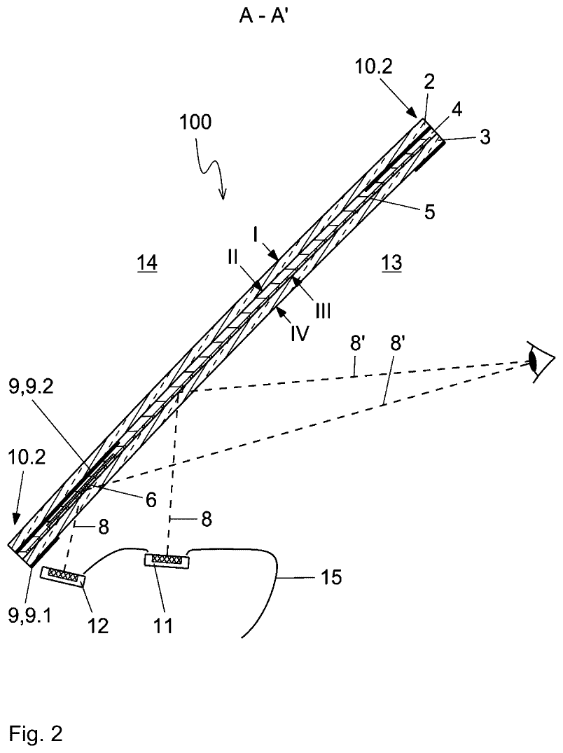

FIG. 2 shows a cross-sectional view of a projection arrangement with the laminated pane of FIG. 1,

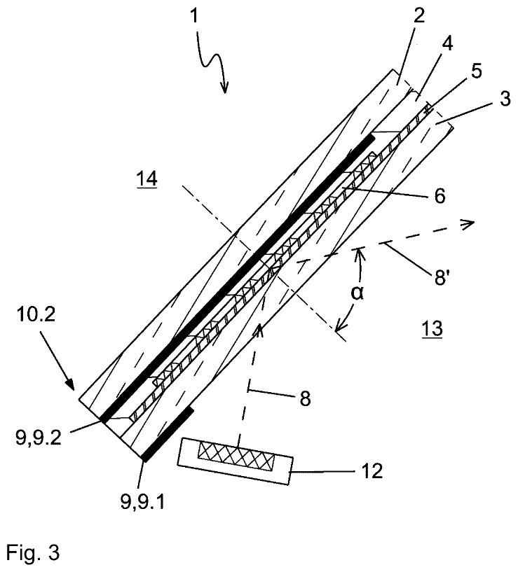

FIG. 3 shows an enlarged edge region of the projection arrangement of FIG. 2 in a cross-sectional view, and

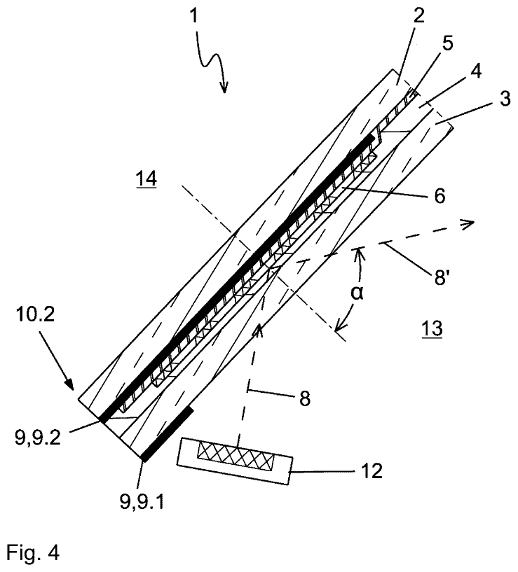

FIGS. 4-7 show further embodiments of the laminated pane according to the invention in a projection arrangement in a cross-sectional view.

FIGS. 1 to 3 show different aspects of an embodiment of the laminated pane 1 according to the invention. FIG. 1 shows the laminated pane 1 according to the invention in the form of a windshield for a vehicle. The laminated pane 1 is shown in a plan view, wherein the view is onto an interior surface IV of the laminated pane 1. FIG. 2 shows the laminated pane 1 as a component of a projection arrangement 100 according to the invention in a cross-sectional view, wherein the projection arrangement 100 is installed in a vehicle. The cross-sectional view of FIG. 2 corresponds to the section line A-A′ of the laminated pane 1, as indicated in FIG. 1. FIG. 3 shows an enlarged detail of the projection arrangement 100 of FIG. 2, wherein the lower edge region is shown adjacent to the lower edge 10.2 of the laminated pane 1.

The laminated pane 1 has an upper edge 10.1 and a lower edge 10.2 as well as two side edges connecting the upper edge 10.1 and the lower edge 10.2 (all together result in a peripheral edge of the laminated pane 1). The lower edge 10.2 (also referred to as the engine edge) of the laminated pane 1 means the edge which faces the floor in the installed position. The upper edge 10.1 (also referred to as the roof edge) of the laminated pane 1 means the edge which faces the vehicle roof in the installed position.

The laminated pane 1 comprises an outer pane 2, an inner pane 3, and a thermoplastic intermediate layer 4 arranged between the outer pane 2 and the inner pane 3. The outer pane 2 has an outer surface I facing away from the thermoplastic intermediate layer 4 and an interior surface II facing the thermoplastic intermediate layer 4. The inner pane 3 has an outer surface III facing the thermoplastic intermediate layer 4 and an interior surface IV facing away from the thermoplastic intermediate layer 4. The outer surface I of the outer pane 11 is also simultaneously the surface of the laminated pane 1 which faces the external environment 14, and the interior surface IV of the inner pane 3 is also simultaneously the surface of the laminated pane 1 which faces the interior 13 of the vehicle. The laminated pane 1 has, for example, a shape and curvature that are customary for windshields.

The outer pane 2 and the inner pane 3 each consist of glass—preferably thermally pre-stressed soda-lime glass—and are transparent to visible light. The outer pane 2 has, for example, a thickness of 2.1 mm, and the inner pane 3 has, for example, a thickness of 1.5 mm. The thermoplastic intermediate layer 4 comprises a thermoplastic plastic, preferably polyvinyl butyral (PVB), ethylene vinyl acetate (EVA) and/or polyethylene terephthalate (PET).

A first opaque masking layer 9, 9.1 is applied to the interior surface IV of the inner pane 3. A second opaque masking layer 9, 9.2 is applied to the interior surface II of the outer pane 2. The first and second masking layers 9.1, 9.2 extend in a frame-like manner along the peripheral edge of the laminated pane 1. The second masking layer 9, 9.2 is applied in the lower edge region directly adjacent to the lower edge 10.2 of the laminated pane 1, in contrast to the upper edge region, directly adjacent to the upper edge 10.1 of the laminated pane 1. The first and the second masking layer 9.1, 9.2 are opaque and obstruct the view of structures arranged on the inside or outside of the laminated pane 1, for example an adhesive bead for gluing the laminated pane 1 into a vehicle body. The first and the second opaque masking layer 9.1, 9.2 consist of an electrically non-conductive material conventionally used for black prints, for example a black-colored screen printing ink which is burnt in.

A partially transparent reflection layer 5 is applied on the outer surface III of the inner pane 3. The partially transparent reflection layer 5 extends over the entire outer surface III of the inner pane 3, with the exception of a peripheral edge region and optionally local region, which, as a communication, sensor or camera window, are intended to ensure the transmission of electromagnetic radiation through the laminated pane 1 (not shown) and therefore are not provided with the partially transparent reflection layer 5. The peripheral uncoated edge region has, for example, a width of 2 cm. It prevents the direct contact of the partially transparent reflection layer 5 with the surrounding atmosphere so that the partially transparent reflection layer 5 in the interior of the laminated pane 1 is protected against corrosion and damage and the vehicle body is electrically insulated from the partially transparent reflection layer 5. The partially transparent reflection layer 5, for example, a thin-film stack containing a silver layer with a layer thickness of 15 nm.

An opaque reflection layer 6 is applied in some regions to the partially transparent reflection layer 5. It is located adjacently to the first masking layer 9, 9.1 in the lower edge region of the laminated pane 1, i.e., is arranged closer to the lower edge 10.2 than to the upper edge 10.1 of the laminated pane 1. In the installed position, the opaque reflection layer 6 is arranged in a vehicle in the vicinity of the dashboard 15. The opaque reflection layer 6 thus extends from the left side edge to the right side edge of the laminated pane 1 without overlapping with the first masking layer 9, 9.1. The opaque reflection layer 6 has, for example, a width of 30 cm. The opaque reflection layer 6 is also arranged in such a way that it completely covers the widened portion of the second masking layer 9, 9.2 in a view through the laminated pane 1 from the interior 13. The opaque reflection layer 6 is therefore arranged in front of the second masking layer 9, 9.2 on the vehicle interior side. In other words, the second masking layer 9, 9.2 completely covers the reflection layer 6 in a view through the laminated pane 1 from the external environment 15. The opaque reflection layer 6 is arranged outside a look-through region 7 provided for looking through, whereas the partially transparent reflection layer 5 extends over the entire look-through region 7 and also extends beyond it. The opaque reflection layer 6 is, for example, a thin-film layer stack consisting of TiO₂ layers and SiO₂ layers which are arranged as desired one above the other. The opaque reflection layer 6 and the partially transparent reflection layer 5 are suitably designed to reflect visible light.

A projector 11 and a further projector 12 are arranged on a dashboard 15 of the vehicle and each project a virtual image in the form of visible light 8 onto the opaque reflection layer 6 or partially transparent reflection layer 5. The projector 11 projects a virtual image in the form of visible light 8 onto the partially transparent reflection layer 5. The region of the partially transparent reflection layer 5 irradiated by the projector 11 is indicated by a dashed trapezoidal region on the laminated pane 1 in FIG. 1. The further projector 12 projects a virtual image in the form of visible light 8 onto the opaque reflection layer 6. The region of the opaque reflection layer 6 irradiated by the further projector 12 is indicated by a dashed region in the form of a strip on the laminated pane 1 in FIG. 1. The visible light 8 of the projector 11 and of the further projector 12 is reflected at the partially transparent reflection layer 5 or the opaque reflection layer 6, and the reflected light 8′ is visually perceived by a viewer (for example, the driver of the vehicle).

The projector 11 irradiates a region of the partially transparent reflection layer 6 in the look-through region 7 of the laminated pane 1, thereby creating an HUD image (head-up display image) for the viewer. The further projector 12 irradiates the opaque reflection layer 6 outside the look-through region 7, which is additionally arranged before a masking layer 9, 9.2. Since the reflection layer 6 is opaque and is arranged in front of an opaque masking layer 9, 9.2, the virtual image is visually perceptible at a higher contrast (comparison to HUD image). This makes it possible to use projectors 12 with a low light intensity, i.e., a lower energy consumption. The projector 11 and the further projector are, for example, light-emitting diode displays (LED display).

Reference is now made to FIGS. 4 through 7, in which enlarged cross-sectional views of various embodiments of the laminated pane 1 are shown. The cross-sectional views of FIGS. 4 through 7 correspond to the section line A-A′ in the lower edge region adjacent to the lower edge 10.2 of the laminated pane 1, as indicated in FIG. 1 and FIG. 2. The variants shown in FIGS. 4 through 7 correspond substantially to the variant of FIGS. 1, 2 and 3 so that only the differences are discussed here, and reference is otherwise made to the description regarding FIGS. 1, 2 and 3.

Unlike the variant of FIGS. 1, 2 and 3, the partially transparent reflection layer 5 in FIG. 4 is not applied to the outer surface III of the inner pane 3 but to the interior surface II of the outer pane 2 and the second masking layer 9, 9.2. The opaque reflection layer 6 is applied in regions to the partially transparent reflection layer 5, as described for FIGS. 1, 2 and 3.

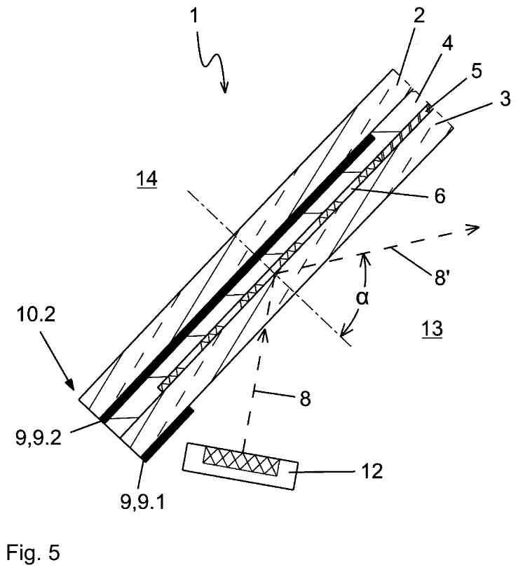

FIG. 5 shows an embodiment of the invention in which the partially transparent reflection layer does not extend over the edge region of the laminated pane adjacent to the lower edge 10.2. The opaque reflection layer 6 is arranged in the edge region of the laminated pane 1 adjacent to the lower edge 10.2 and does not overlap with the partially transparent reflection layer 5 in a view through the laminated pane 1. The opaque reflection layer 6 is applied to the outer surface III of the inner pane 3. In that the partially transparent reflection layer 5 and the opaque reflection layer 6 do not overlap with one another, visual color effects which may arise due to interferences of the reflected light 8′ can be avoided.

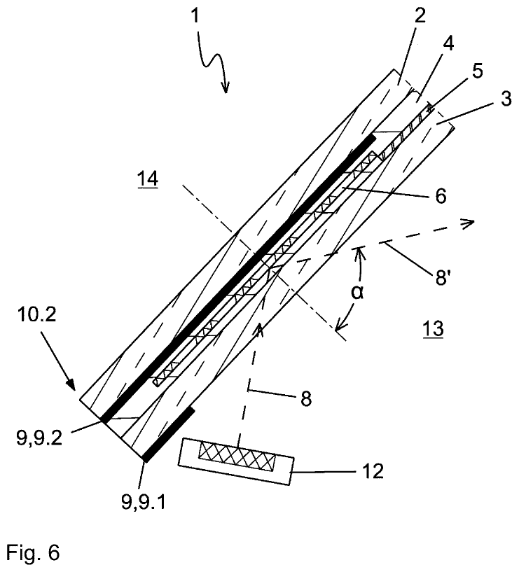

In the embodiment of the invention shown in FIG. 6, the opaque reflection layer 6 is a coated, reflective film instead of a coating which is applied to the partially transparent reflection layer 5. The film is formed, for example, on the basis of PET and coated with a thin-film layer stack consisting of TiO₂ layers and SiO₂ layers. The opaque reflection layer 6 is arranged within the thermoplastic intermediate layer 4. The opaque reflection layer 6 is arranged between two thermoplastic composite films, for example before the lamination process. In order to compensate for differences in thickness, the thermoplastic composite films can be formed thinner in the region that is congruent with the opaque reflection layer 6 than in the other regions. The partially transparent reflection layer 6 is arranged as described and shown for FIG. 5.

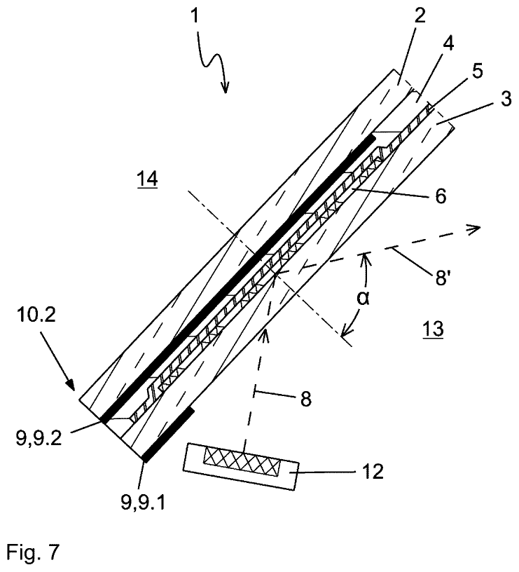

FIG. 7 shows an embodiment in which the opaque reflection layer 6 is applied to the outer surface III of the inner pane 3 and the partially transparent reflection layer 5 is applied to the opaque reflection layer 6 in the region overlapping the opaque reflection layer 6. In the region not overlapping the opaque reflection layer 6, the partially transparent reflection layer 5 is applied to the outer surface III of the inner pane 3. As a result, the reflection properties of the opaque reflection layer 6 are reduced less strongly since the light 8′ reflected by the opaque reflection layer 6 does not have to be transmitted through the partially transparent reflection layer 5.

### REFERENCE SIGNS

1 Laminated pane
2 Outer pane
3 Inner pane
4 Thermoplastic intermediate layer
5 Partially transparent reflection layer
6 Opaque reflection layer
7 Look-through region
8 Visible light
8′ Reflected light
9 Opaque masking layer
9.1 First masking layer
9.2 Second masking layer
10.1 Upper edge of the laminated pane 1
10.2 Lower edge of the laminated pane 1

### 11 Projector

12 Further projector

### 13 Interior

14 External environment

### 15 Dashboard

100 Projection arrangement
I Outer surface of the outer pane 2
II Interior surface of the outer pane 2
III Outer surface of the inner pane 3
IV Interior surface of the inner pane 3
A-A′ Section line

1. A laminated pane for a projection arrangement, comprising:
an outer pane, a thermoplastic intermediate layer, and an inner pane,
a partially transparent reflection layer, and
an opaque reflection layer,
wherein the partially transparent reflection layer and the opaque reflection layer are arranged between the outer pane and the inner pane,
wherein the opaque reflection layer is arranged outside a look-through region of the laminated pane and the partially transparent reflection layer extends over at least the entire look-through region of the laminated pane, and
wherein the opaque reflection layer reflects visible light to an extent of at least 30% and the partially transparent reflection layer reflects visible light to an extent of at most 30%.

2. The laminated pane according to claim 1, wherein the opaque reflection layer is arranged in front of a masking layer in a view through the laminated pane.

3. The laminated pane according to claim 1, wherein the partially transparent reflection layer extends over at least 90% of a surface of the laminated pane.

4. The laminated pane according to claim 1, wherein the opaque reflection layer is arranged in an upper or lower edge region adjacent to an upper edge or a lower edge of the laminated pane.

5. The laminated pane according to claim 1, wherein the partially transparent reflection layer contains or consists of at most 2 silver layer.

6. The laminated pane according to claim 1, wherein the partially transparent reflection layer has a layer thickness of 1 nm to 100 nm.

7. The laminated pane according to claim 1, wherein the opaque reflection layer reflects visible light to an extent of at least 40%.

8. The laminated pane according to claim 1, wherein the partially transparent reflection layer reflects visible light to an extent of at least 10%.

9. The laminated pane according to claim 1, wherein the opaque reflection layer contains silicon, aluminum, zirconium, nickel, chromium, boron-doped silicon, silicon-zirconium mixed nitride, silicon nitride, titanium oxide, silicon oxide, titanium carbide, zirconium carbide, silicon-zirconium aluminum and/or mixtures thereof.

10. The laminated pane according to claim 1, wherein the opaque reflection layer is applied to an outer surface of the inner pane facing the thermoplastic intermediate layer.

11. The laminated pane according to claim 1, wherein the opaque reflection layer is applied to a region of the partially transparent reflection layer.

12. The laminated pane according to claim 1, wherein the partially transparent reflection layer is applied to an outer surface of the inner pane facing the thermoplastic intermediate layer.

13. A projection arrangement comprising:
a laminated pane according to claim 1,
a projector which projects an image onto the partially transparent reflection layer, and
a further projector which is configured to project an image onto the opaque reflection layer.

14. A method for producing a laminated pane according to claim 1, comprising:
providing a layer stack formed of the outer pane, the thermoplastic intermediate layer and the inner pane,
arranging the partially transparent reflection layer and the opaque reflection layer between the outer pane and the inner pane, and
laminating the layer stack to form the laminated pane.

15. A method comprising providing a laminated pane according to claim 1 in a vehicle of transportation for traffic on land, in the air or in water and/or decorative individual piece, or as an installed component in furniture, devices or a buildings.

16. The laminated pane according to claim 5, wherein the partially transparent reflection layer contains or consists of one silver layer.

17. The laminated pane according to claim 6, wherein the partially transparent reflection layer has a layer thickness of 10 nm to 50 nm.

18. The laminated pane according to claim 7, wherein the opaque reflection layer reflects visible light to an extent of at least 70%.

19. The laminated pane according to claim 8, wherein the partially transparent reflection layer reflects visible light to an extent of at least 15%.

20. The method according to claim 15, wherein the laminated pane is a windshield, a rear pane, a side pane and/or a glass roof of the vehicle.
